(19) United States
(12) Patent Application Publication
(10) Pub. No.: US 2024/0095777 A1
(43) Pub. Date: Mar. 21, 2024

(54) INPUT NORMALIZATION FOR MODEL BASED RECOMMENDATION ENGINES

(71) Applicant: INTUIT INC., Mountain View, CA (US)

(72) Inventor: Akshay RAVINDRAN, Mountain View, CA (US)

(73) Assignee: INTUIT INC., Mountain View, CA (US)

(21) Appl. No.: 17/932,606

(22) Filed: Sep. 15, 2022

(51) Int. Cl. G06Q 30/02

(52) U.S. Cl. CPC G06Q 30/0271; G06Q 30/0201

(57) ABSTRACT

In one or more embodiments, transaction data between multiple users and multiple merchants is retrieved. The retrieved transaction data is aggregated for each of the multiple users and each of the multiple merchants. The aggregated data may then be normalized. An example normalization process may include income normalization, where a user's total transaction amount at a particular merchant is normalized by the user's income. Other forms of normalization may also be employed. Using the normalized data, user-merchant affinity may be predicted based on collaborative filtering models, cascading tree models, and or cosine similarity models. A recommendation engine may provide personalized advertisements based on the predicted affinity. Because of the normalization of the data, the affinity and therefore the recommendation is less biased toward larger merchants.

### BACKGROUND

Machine learning models and other models are used for predicting what events or behaviors are likely based on the current records of events and behaviors. One use case for the models is to predict user behavior. The prediction is based on training and or generating a model on known user behavior, which is often recorded in a database. The model may be deployed to take in new, incoming data, which is generally similar to the known data used for training the model, and then predict user behavior based on this incoming data. One example user behavior is the user's affinity toward a particular entity or product.

Conventional models for predicting user behavior, however, have several technical shortcomings, particularly for those predicting user affinity. For instance, the data used for training/generating the conventional models typically requires the user's expressed affinity. To take an example relevant for streaming movie providers, users express their affinities to the streamed movies by providing ratings. That is, users have to affirmatively engage with the rating mechanism (e.g., by clicking on the number of stars). The affirmative engagement from the users may not always be possible; and even when possible, it is cumbersome for them to take the extra steps (e.g., clicking) to express their affinity.

For other types of models, data of affirmative user engagement may not necessarily be required. In an example use case for a user shopping with multiple merchants, collected transaction data may show the affinities of the user towards the multiple merchants. The collected transaction data, however, is generally biased towards larger merchants because both the number of transactions and amount transacted are generally higher for the larger merchants. Therefore, user affinity prediction using biased training data results in a bias towards the larger merchants.

As such, a significant improvement for training, generating, and deploying models for user affinity prediction is therefore desired.

### SUMMARY

Embodiments disclosed herein solve the aforementioned technical problems and may provide other solutions as well. In one or more embodiments, transaction data between multiple users and multiple merchants is retrieved. The retrieved transaction data is aggregated for each of the multiple users and each of the multiple merchants. The aggregated data may then be normalized. An example normalization process may include income normalization, where a user's total transaction amount at a particular merchant is normalized by the user's income. Other forms of normalization may also be employed. Using the normalized data, user-merchant affinity may be predicted based on collaborative filtering models, cascading tree models, and or cosine similarity models. A recommendation engine may provide personalized advertisements based on the predicted affinity. Because of the normalization of the data, the affinity and therefore the recommendation is less biased toward larger merchants.

In an example embodiment, a computer implemented method is provided. The method may include retrieving transaction data between a plurality of users and a plurality of merchants from one or more databases and aggregating the transaction data for each of the plurality of users and each of the plurality of merchants. The method may also include normalizing the aggregated transaction data for each of the plurality of users and each of the plurality of merchants. The method may further include generating an affinity score between at least one user and at least one merchant using the normalized data with one or more models, such that the affinity score is not biased toward larger merchants; and outputting a personalized recommendation to the user based on the affinity score.

In another embodiment, a system is provided. The system may include a non-transitory storage medium storing computer program instructions and one or more processors configured to execute the computer program instructions to cause operations that may include: retrieving transaction data between a plurality of users and a plurality of merchants from one or more databases and aggregating the transaction data for each of the plurality of users and each of the plurality of merchants. The operations may also include normalizing the aggregated transaction data for each of the plurality of users and each of the plurality of merchants. The operations may further include generating an affinity score between at least one user and at least one merchant using the normalized data with one or more models, such that the affinity score is not biased toward larger merchants; and outputting a personalized recommendation to the user based on the affinity score.

### BRIEF DESCRIPTION OF THE FIGURES

FIG. 1 shows an example system configured for providing recommendations based on normalized aggregated data, based on the principles disclosed herein.

FIG. 2 shows a flow diagram of an example method of generating models for providing recommendations based on normalized aggregated data, in accordance with the principles disclosed herein.

FIG. 3 shows a flow diagram of an example method of deploying the models (generated by the method in FIG. 2) for providing recommendations based on normalized aggregated data, in accordance with the principles disclosed herein.

FIG. 4 shows an example distribution curve of size of merchants and the range of recommended merchants, based on the principles disclosed herein.

FIG. 5 shows a block diagram of an example computing device that implements various features and processes, based on the principles disclosed herein.

### DETAILED DESCRIPTION OF EXAMPLE EMBODIMENTS

Conventional recommendation engines are heavily biased towards larger merchants because transaction data is heavily skewed toward the larger merchants. Advertisements based on these recommendation engines therefore necessarily have a smaller range tending to cover just the larger merchants, which is undesirable. Embodiments disclosed herein improve upon these recommendation engines by normalizing data before generating and using recommendation models. In one or more embodiments, the normalization may include income normalization. Some examples of the recommendation models include collaborative filters such as a user-user similarity matrix, a merchant-merchant similarity matrix, and or a user-merchant similarity matrix. Machine learning models may be deployed to learn latent features by factorizing one or more of these matrices. Other examples of recommendation models include decision trees (e.g., boosted decision trees) and or cosine similarity scores. Because the data used for generating one or more of these models is normalized, the predicted recommendation and advertisements tend to be less biased toward the larger merchants. The users may therefore discover smaller merchants providing similar items.

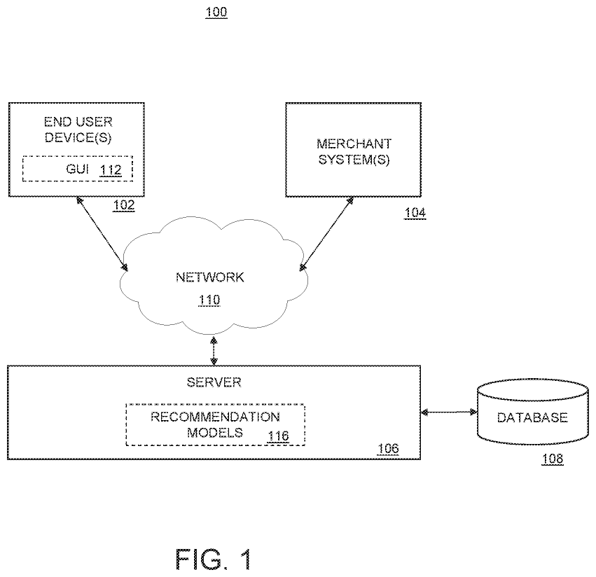

FIG. 1 shows an example system 100 configured to provide recommendations based on normalized aggregated data, in accordance with the principles disclosed herein. As shown, the system 100 comprises end user device(s) 102 (a single instance referred to as an end user device 102 and multiple instances referred to as end user devices 102), merchant system(s) 104 (a single instance referred to as a merchant system 104 and multiple instances referred to as merchant systems 104), a server 106, a database 108, and a network 110. It should, however, be understood these are example components and systems with additional, alternative, or fewer number of components should be considered within the scope of this disclosure.

The end user devices 102 may be operated by corresponding users. Each of the end user devices 102 may include a graphical user interface 112 that renders an application to access and or modify different functionalities provided by the system 100 and or the merchant systems 104. The user devices 102 may include, for example, mobile computing devices (e.g., smartphone), tablet computing devices, laptop computing devices, desktop computing devices, and or any type of computing devices. Users may include individuals such as, for example, subscribers, customers, clients, or prospective clients, of an entity associated with the server 106. The users may also include, for example, subscribers, customers, clients, or prospective clients of the merchant systems 104. The users may generally use the application or a browser rendered on the GUI 112 to access the server 106. In some instances, the application may include Mint®, Credit Karma®, and or QuickBooks® products offered by Intuit® of Mountain View, California. The users may also use the application or the browser to access the various merchant systems 104. In some embodiments, the users may use the server 106 (i.e., through an application associated with the server 106) to access the merchant systems 104.

The merchant systems 104 may be operated by various merchants providing goods and services (generalized as “items” throughout this disclosure). For instance, the merchant systems 104 may be operated by online and or brick-and-mortar retailers to sell the items to a user. In other instance, the merchant systems 104 may be operated by a bank providing a banking service to its users. As described above, the end user devices 102 in some instances access the merchant systems 104 through the server 106. The merchant systems 104 may include, for example, mobile computing devices (e.g., smartphone), tablet computing devices, laptop computing devices, desktop computing devices, and or any type of computing devices.

The network 110 may include any type of network configured to provide communication functionalities within the system 100. To that end, the network 110 may include the Internet and or other public or private networks or combinations thereof. The network 110 therefore should be understood to include any type of circuit switching network, packet switching network, or a combination thereof. Non-limiting examples of the network 110 may include a local area network (LAN), metropolitan area network (MAN), wide area network (WAN), and the like.

The server 106 may include any type of computing device or combination of computing devices. Non-limiting examples the computing devices forming the server 106 include server computing devices, desktop computing devices, laptop computing devices, and or the like. The server 106 may also include any combination of geographically distributed or geographically clustered computing devices. The server 106 may include recommendation models 116 that may be trained/generated and deployed using one or more embodiments disclosed herein.

The database 108 may be in communication with and or hosted by the server 106. The database 108 may include any kind of database. Some non-limiting examples of the database 108 include, a relational database, an object-oriented database, and or the like. The database 108 may generally store the transaction data between the end user devices 102 and the merchant systems 104. The transaction data may be retrieved and or received from the merchant systems 104 and or the end user device 102 on a daily basis, e.g., a daily running extract, transform, load (ETL) job. The transaction data is to generate/train and deploy different recommendation models 116, as described throughout this disclosure.

The recommendation models 116 may comprise any type of models that may be generated/trained and deployed based on the principles disclosed herein. In some embodiments, the recommendation models are collaborative filtering models comprising user-user similarity metrics, merchant-merchant similarity matrices (also referred to as item-item similarity metrics), and or user-merchant similarity matrices. These matrices are generated using normalized data and therefore reduces the likelihood bias in the recommendations. The normalized data may be used to generate other models such as extreme gradient boosted model, boosted decision tree, and or any other type of decision tree models. The normalized data may further be used to generate other models such as cosine similarity models. These are just a few examples of the recommendation models and should not be considered limiting. For instance, a different machine learning model may be used to predict latent features in the one or more of the user-user similarity matrices, merchant-merchant similarity matrices, and user-merchant similarity matrices through matrix factorization.

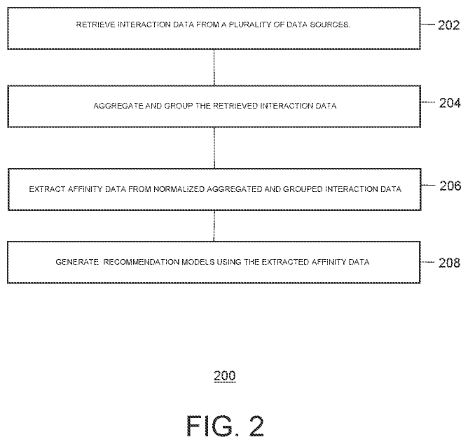

FIG. 2 shows a flow diagram of an example method 200 of generating models for providing recommendations based on normalized aggregated data, in accordance with the principles disclosed herein. The method 200 may be performed by any component, or any combination of components shown in FIG. 1. It should also be understood that the steps shown in FIG. 2 and described herein are merely examples, and methods with additional, alternative, and fewer number of steps should also be considered within the scope of this disclosure. It should further be understood that the discrete steps and their order are merely exemplary and are not for showing a single sequence of operations.

At step 202, interaction data is retrieved from various sources. The interaction data may include, for example, transaction data between different users and merchants (e.g., as shown in FIG. 1, transaction data between user devices 102 and merchant systems 104). In an embodiment, the transaction data may be stored in a single database (e.g., database 108 shown in FIG. 1) that receives data from several sources. For example, an extract, transform, and load (ETL) job is run every day to add new transactions to the single database. In other embodiments, the transaction data may be stored in multiple databases. The databases may be, for example, geographically distributed across different database servers.

At step 204, the retrieved interaction data is aggregated and grouped. In the embodiment with transaction data (i.e., as an example of the interaction data), the data is grouped according to the users or merchants. For example, the transaction data is aggregated for each user across the different merchants. Additionally, the transaction data is aggregated for each merchant across different users. The aggregated data source typically provides a better representation of the transaction data compared to the retrieved individual data points. In some instances, a Spark Job may be performed to transform the retrieved individual data points into aggregated and grouped data.

At step 206, affinity data is extracted from normalized aggregated and grouped interaction data. Normalization is typically desired because it may reduce a skewness of the interaction data toward large entities, e.g., in the case of transaction data, skewness towards large merchants. Such skewness, if not corrected, may bias the downstream recommendation engines, e.g., recommendation engines using the models, toward the larger merchants. Therefore, different normalization steps may be performed to reduce the skewness and bias.

In an example embodiment, an income-based normalization process is performed on the transaction data. For instance, a user X with an income of $10,000 may spend $1500 with Merchant A, while another user Y with an income of $3000 may spend $1000 with the same Merchant A. A traditional model using non-normalized data gives a higher weight to user X because the spend (i.e., amount spent) is higher by $500 compared to user Y. But, it can be seen that user Y has a higher affinity for Merchant A because the spend-to-income ratio is 1/3, compared to user X, whose spend-to-income ratio for Merchant A is 3/20. Therefore, normalization may typically reduce this and other biases and the resulting skewness of the data. Regarding transaction data, for example, larger merchants generally have a higher dollar spend compared to smaller merchants—the higher dollar spend will always indicate a higher affinity towards the larger merchants. Normalization may therefore reduce the skewness of the data and reduce the bias towards the larger merchants.

The income-based normalization technique is just an example technique that may be used and it should be appreciated that other types of normalizations are to be considered within the scope of this disclosure. As another example, for calculating transaction-based affinity, normalization can be based on the number of transactions vs. the amount spent. A larger number of transactions by a user with the same merchant may be a more accurate representation of the affinity compared to a pure spend comparison. Therefore, the spend amount may be scaled (i.e., normalized) by the number of transactions, e.g., if the total spend for Merchant A is the same between a user X and user Y and if user X has a higher number of transactions, the normalization may indicate that user X has more affinity for Merchant A.

In one or more embodiments, the normalization may be based on using a size factor for the merchants. For example, larger merchants may be assigned a smaller size factor and smaller merchants may be assigned a larger size factor to compensate for the skewness due to their sizes. That is, dollar amounts spent on the smaller merchants may be weighed heavily compared to the dollar amounts spent on the larger merchants.

In one or more embodiments, the normalization may be based on the type of the purchases. For instance, purchases for basic goods (e.g., food items) may not necessarily mean that the corresponding users have an affinity for the merchant. On the other hand, purchases of luxury items may indicate that the user has an affinity for that particular merchant. Accordingly, purchases for basic items may be weighted lower compared to the purchase of luxury items. This normalization may also be expressed as being based on the type of merchant. For example, a merchant may be basic goods supplier (e.g., a grocery store) and another merchant may be a luxury goods supplier (e.g., a high-end fashion store). An affinity for the basic goods supplier may be weighted down compared to the affinity for the luxury goods supplier.

In one or more embodiments, the normalization may include an average price per item. This normalization may be used to augment (or used instead of) the normalization based on the number of transactions. Particularly, for a certain spend at a merchant, a lower average price for items indicates a higher affinity because of the higher number of transactions compared to a higher average price for items that will correspond to a lower number of transactions.

In one or more embodiments, the normalization may also be based on the number of visits to a merchant's website or physical store (collectively referred to as “encounters” between the users and the merchants). For the same spend, a larger number of encounters may indicate a higher affinity compared to a smaller number of encounters. In other words, for the same spend between different users, a spend associated with a larger number of encounters may be associated with a higher level of affinity.

In one or more embodiments, the normalization may be based on availability of alternates. For instance, first a first category of items offered by many merchants (e.g., different brands of toothpastes offered by multiple merchants), if a user buys a certain brand or from a certain merchant, the affinity score toward the merchant is higher. However, for a second category of goods offered by only a few merchants and a user prefers a certain merchant, the affinity is much lower.

In one or more embodiments, the normalization is based on users' previous interaction with the provided recommendations (e.g., in the form of personalized advertisements). For example, even if a particular user has a lower affinity with a merchant, but has interacted with the corresponding recommendation more often, a normalization factor may be used to weigh the merchant more in the model generation training.

At step 208, recommendation models are generated for the extracted affinity data. In some embodiments, recommendation models may include collaborating filtering models. The collaborative filtering models may include user-user similarity models, item-item similarity models (also referred to as merchant-merchant similarity models), and or user-item similarity models (also referred to as user-merchant similarity models) that may be generated from the user-user similarity models and item-item similarity models.

The user-user similarity models use collaborative filtering based on a similarity score between different users (e.g., user pairs). The similarity score may be based on different distance metrics such as cosine similarity, Euclidean distance, correlation, and or other types of the distance metrics. The distance metrics are used to select similar users. The recommendation is based on the purchase behavior of similar users. For instance, if user X is similar to user Y, and user Y bought an item A but user X has not, then user X is provided with a recommendation for item A. As items are sold by merchants, items and the merchants are used interchangeably throughout the disclosure. Generating a user-user similarity model may include generating a user-user similarity matrix, e.g., if there are N users, the similarity model will generate a N*N similarity matrix.

The item-item similarity models use collaborative filtering based on a similarity score between different items (e.g., item pairs). As with the user-user similarity models, the similarity score between two items may be based on different distance metrics such as cosine similarity, Euclidean distance, correlation, and or other types of distance metrics. The distance metrics are then used to select similar items. The recommendation engine is based on the similarity between the items. For example, if user X has purchased item A and user Y has purchased item B, and item A and B are found to have a high similarity score, then item B is recommended to user X and or item A is recommended to user Y. Generating an item-item similarity model may include generating an item-item similarity matrix, e.g., if there are M users the similarity model will generate a M*M similarity matrix.

The user-item similarity models may be based on matrix factorization between the user-user similarity matrix (e.g., of N*N dimensions) and the item-item similarity matrix (e.g., of M*M dimensions). Matrix factorization may generate latent features. Continuing with the above example, if the user-user similarity matrix is represented as A, the item-item similarity matrix is represented as B, and the user-item similarity matrix is represented as C; then an expression may be defined, using matrix factorization as AX*XB=C. The X matrix may indicate the latent features, which can be extracted by training one or more machine learning models.

Other examples of machine learning models include an extreme gradient (XG) Boosted model, Boosted Decision Tree Models, and cosine similarity models. These models may provide predictions on a user's affinity for an item (and by extension, a merchant selling the item) based on the historical transaction habits of the user. Particularly, XG Boosted models and Boosted Decision Tree Models use a cascade of decision trees sequentially, but slow down the learning by the trees using a weightage or shrinkage factor. The slowdown in learning avoids the problem of these models overfitting the training data. The cosine similarity models are based on the dot product (i.e., cosine product) of features of different transactions to determine the similarity between the transactions.

It should, however, be understood that the aforementioned recommendation models are just but a few examples. Other types of models (e.g., statistical models and or machine learning models) and their different combinations may be used to realize the same or similar functionality without deviating from the scope of this disclosure.

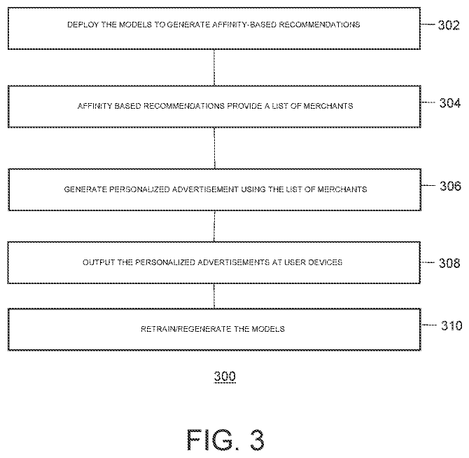

FIG. 3 shows a flow diagram of an example method 300 of deploying the models (generated by the method 20 in FIG. 2) for providing recommendations based on normalized aggregated data, in accordance with the principles disclosed herein. The method 300 may be performed by any component, or any combination of components shown in FIG. 1. It should also be understood that the steps shown in FIG. 3 and described herein are merely examples, and methods with additional, alternative, and fewer number of steps should also be considered within the scope of this disclosure. It should further be understood that the discrete steps and their order are merely examples and are not for showing a single sequence of operations.

At step 302, the models (i.e., the recommendation models) are deployed to generate affinity-based recommendations. The affinities are between a plurality of users and a plurality of merchants. The affinities are, in some embodiments, provided as affinity scores—with a numerically higher score representing a higher affinity and vice versa. These affinity scores also can be represented as being between the plurality of users and a plurality of items (i.e., the items sold by the plurality of merchants). The affinity scores may indicate how likely a user is to purchase from a corresponding merchant. The recommendations therefore may be predicated on these affinity scores—merchants similar to a merchant with a higher affinity score with a user may be recommended to the user (as detailed below).

At step 304, the affinity-based recommendations may provide a list of merchants. For example, a list of merchants with ascending order or descending order of affinity scores may be generated. Merchants within the list may generally provide the same or similar products and or services. Because the recommendation engines are generated using normalized training data, the bias in the list may be minimized. That is, the bias towards larger merchants with higher volumes of transactions may be reduced.

At step 306, personalized advertisements using the list of merchants may be generated. In an embodiment, the personalized advertisements may be for merchants that are similar to another merchant having a high affinity score with a corresponding user. In an example use case, a user may use banking services from a large Bank A. The user may have a high affinity score with Bank A and its service structure, e.g., credit card fees, minimum deposit requirement, locations of ATMs, hours of operation, etc. The advertisement may be for a Bank B, which may be smaller to Bank A, but offering a similar service structure. Using the conventional models, the advertisements would be highly skewed toward larger merchants. In the above example, the advertisements would be highly likely for a Bank C that is comparable in size to Bank A. However, using the normalized data for training the machine learning models, Bank B can be “discovered” and used for as advertisement.

At step 308, the personalized advertisements are output at user devices. The personalized advertisements can be output as pop-up advertisements on a browser or an application (e.g., a smartphone application). These advertisements can also be provided as an e-mail, a text message, a phone call, and or by using any other communication medium. The personalized advertisements may have a higher realization rate because they are based on the user's affinity scores and also not biased toward the well-known merchants.

At step 310, the models may be retrained and or regenerated. The retraining and or regeneration may be continuous based on the users' interaction with the personalized advertisements. Particularly, the users' selection or non-selection of the advertisements may be used as new data points for retraining and retraining the model. The retraining and regeneration may minimize undesired outcomes (i.e., a non-selection of the advertisement) and maximize desired outcomes (i.e., selection of the advertisement).

One example of model retraining or regeneration may include assigning a higher weightage to a merchant that the user selects more often in the personalized advertisements, even if the merchant is associated with a lower affinity score during the current iteration. That is, models may learn new information on affinity based on observed behavior of the user to further modify the generation of downstream recommendations in future iterations.

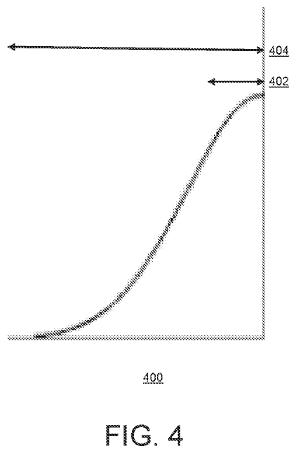

FIG. 4 shows an example distribution curve 400 for size of merchants and the range of recommended merchants, based on the principles disclosed herein. Particularly, the distribution curve 400 according to the size of the merchants is shown, where the size increases along the x-axis. As shown, the recommendation engine using conventional technics will generate recommendations in region 402, heavily biased toward larger merchants. However, the recommendations using the principles disclosed herein have a reduced bias, and therefore the recommendation may be in region 404, and likely to recommend merchants of any size based on the users' affinity.

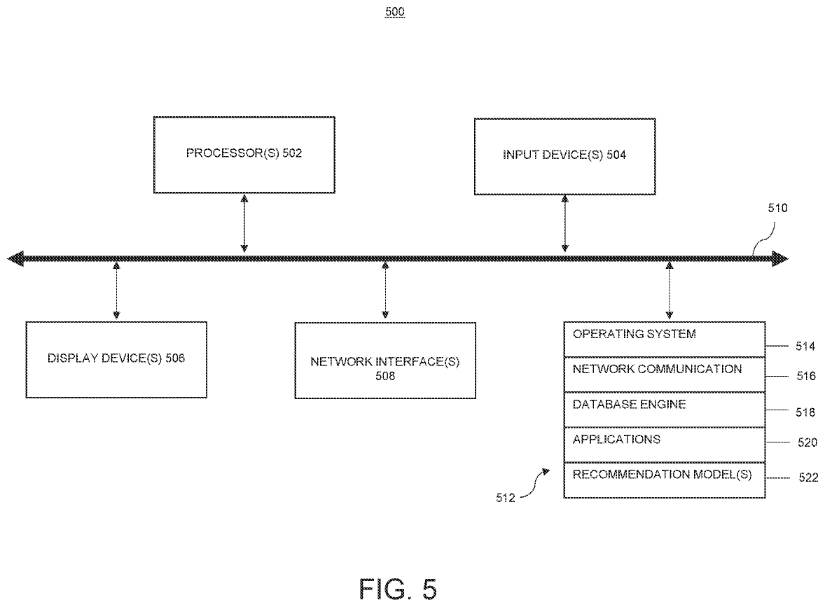

FIG. 5 shows a block diagram of an example computing device 500 that implements various features and processes, based on the principles disclosed herein. For example, computing device 500 may function as a server 106, end user device(s) 102, agent system(s) 104, or a portion or combination thereof in some embodiments. The computing device 500 also performs one or more steps of the methods 200 and 300 disclosed herein. The computing device 500 is implemented on any electronic device that runs software applications derived from compiled instructions, including without limitation personal computers, servers, smart phones, media players, electronic tablets, game consoles, email devices, etc. In some implementations, the computing device 500 includes one or more processors 502, one or more input devices 504, one or more display devices 506, one or more network interfaces 508, and one or more computer-readable media 512. Each of these components is be coupled by a bus 510.

Display device 506 includes any display technology, including but not limited to display devices using Liquid Crystal Display (LCD) or Light Emitting Diode (LED) technology. Processor(s) 502 uses any processor technology, including but not limited to graphics processors and multi-core processors. Input device 504 includes any known input device technology, including but not limited to a keyboard (including a virtual keyboard), mouse, track ball, and touch-sensitive pad or display. Bus 510 includes any internal or external bus technology, including but not limited to ISA, EISA, PCI, PCI Express, USB, Serial ATA or FireWire. Computer-readable medium 512 includes any non-transitory computer readable medium that provides instructions to processor(s) 502 for execution, including without limitation, non-volatile storage media (e.g., optical disks, magnetic disks, flash drives, etc.), or volatile media (e.g., SDRAM, ROM, etc.).

Computer-readable medium 512 includes various instructions 514 for implementing an operating system (e.g., Mac OS®, Windows®, Linux). The operating system 514 may be multi-user, multiprocessing, multitasking, multithreading, real-time, and the like. The operating system 514 performs basic tasks, including but not limited to: recognizing input from input device 504; sending output to display device 506; keeping track of files and directories on computer-readable medium 812; controlling peripheral devices (e.g., disk drives, printers, etc.) which can be controlled directly or through an I/O controller (not shown); and managing traffic on bus 510. Network communications instructions 516 establish and maintain network connections (e.g., software for implementing communication protocols, such as TCP/IP, HTTP, Ethernet, telephony, etc.).

Database engine 518 may interact with different databases accessed by the computing device 500. For example, the databases may comprise training data to train machine learning models. The databases may also provide access to real-time data to deploy the trained machine learning models.

Applications 520 may comprise an application that uses or implements the processes described herein and/or other processes. The processes may also be implemented in the operating system.

Recommendation model(s) 522 may comprise one or more models trained, generated, deployed, retrained, and or regenerated—using normalized aggregated transaction data—to implement one or more recommendation functionalities described throughout this disclosure.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment. In one embodiment, this may include Python. The computer programs therefore are polyglots.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

1. A computer implemented method comprising:
retrieving transaction data corresponding to transactions between a plurality of users and a plurality of merchants from one or more databases;
aggregating the transaction data for each of the plurality of users and each of the plurality of merchants;
normalizing the aggregated transaction data for each of the plurality of users and each of the plurality of merchants and based on:
corresponding incomes of the plurality of users,
corresponding numbers of transactions between the plurality of users and the plurality of merchants,
corresponding sizes of the plurality of merchants,
types of purchases for the transactions,
average price per item in the transactions,
corresponding number of encounters between the plurality of users and the plurality of merchants, and
availability of alternates for items in the transactions;
using a first collaborative filtering model on the normalized data to generate a user-user similarity matrix;
using a second collaborative filtering model on the normalized data to generate a merchant-merchant similarity matrix;
detecting latent features based on using a machine learning model on the user-user similarity matrix and the merchant-merchant similarity matrix;
generating an affinity score between at least one user and at least one merchant using the detected latent features such that the affinity score is not biased toward larger merchants;
generating, based on the affinity score, a personalized recommendation of a smaller merchant offering similar services as a larger merchant, such that the user discovers the smaller merchant;
causing an output of a personalized recommendation as a pop-up notification to a mobile device of the user based on the affinity score; and
retraining the machine learning model by assigning a higher weightage to the smaller merchant responsive to the user selecting the personalized recommendation.

2. The computer implemented method of claim 1, wherein normalizing the aggregated transaction data comprises:
normalizing the aggregated transaction data based on corresponding incomes of the plurality of users.

3. (canceled)

4. (canceled)

5. The computer implemented method of claim 1, wherein outputting the personalized recommendation comprises:
outputting, to the mobile device, an advertisement with the personalized recommendation.

6. The computer implemented method of claim 1, wherein generating the affinity score between the at least one user and the at least one merchant comprises:
generating a user-merchant similarity matrix based on the user-user similarity matrix and the merchant-merchant similarity matrix; and
using the user-merchant similarity matrix to generate the affinity score.

7. (canceled)

8. The computer implemented method of claim 6, wherein detecting the latent features comprises:
learning, using the machine learning model, the latent features from the user-user similarity matrix, the merchant-merchant similarity matrix, and the user-merchant similarity matrix.

9. The computer implemented method of claim 1, wherein generating the affinity score between the at least one user and the at least one merchant comprises:
using at least one of extreme gradient boosted model or a boosted decision tree model on the normalized data to generate the affinity score.

10. The computer implemented method of claim 1, wherein generating the affinity score between the at least one user and the at least one merchant comprises:
using cosine similarities in the normalized data to generate the affinity score.

11. A system comprising:
a non-transitory storage medium storing computer program instructions; and
one or more processors configured to execute the computer program instructions to cause operations comprising:
retrieving transaction data corresponding to transactions between a plurality of users and a plurality of merchants from one or more databases;
aggregating the transaction data for each of the plurality of users and each of the plurality of merchants;
normalizing the aggregated transaction data for each of the plurality of users and each of the plurality of merchants and based on:
corresponding incomes of the plurality of users,
corresponding numbers of transactions between the plurality of users and the plurality of merchants,
corresponding sizes of the plurality of merchants,
types of purchases for the transactions,
average price per item in the transactions,
corresponding number of encounters between the plurality of users and the plurality of merchants, and
availability of alternates for items in the transactions;
using a first collaborative filtering model on the normalized data to generate a user-user similarity matrix;
using a second collaborative filtering model on the normalized data to generate a merchant-merchant similarity matrix;
detecting latent features based on using a machine learning model on the user-user similarity matrix and the merchant-merchant similarity matrix;
generating an affinity score between at least one user and at least one merchant using the detected latent features such that the affinity score is not biased toward larger merchants;
generating, based on the affinity score, a personalized recommendation of a smaller merchant offering similar services as a larger merchant, such that the user discovers the smaller merchant;
causing an output of a personalized recommendation as a pop-up notification to a mobile device of the user based on the affinity score; and
retraining the machine learning model by assigning a higher weightage to the smaller merchant responsive to the user selecting the personalized recommendation.

12. The system of claim 11, wherein normalizing the aggregated transaction data comprises:
normalizing the aggregated transaction data based on corresponding incomes of the plurality of users.

13. (canceled)

14. (canceled)

15. The system of claim 11, wherein outputting the personalized recommendation comprises:
outputting, to the mobile device, an advertisement with the personalized recommendation.

16. The system of claim 11, wherein generating the affinity score between the at least one user and the at least one merchant comprises:
generating a user-merchant similarity matrix based on the user-user similarity matrix and the merchant-merchant similarity matrix; and
using the user-merchant similarity matrix to generate the affinity score.

17. (canceled)

18. The system of claim 16, wherein detecting the latent features comprises:
learning, using the machine learning model, the latent features from the user-user similarity matrix, the merchant-merchant similarity matrix, and the user-merchant similarity matrix.

19. The system of claim 11, wherein generating the affinity score between the at least one user and the at least one merchant comprises:
using at least one of extreme gradient boosted model or a boosted decision tree model on the normalized data to generate the affinity score.

20. The system of claim 11, wherein generating the affinity score between the at least one user and the at least one merchant comprises:
using cosine similarities in the normalized data to generate the affinity score.
